(19) United States
(12) Patent Application Publication
(10) Pub. No.: US 2007/0112165 A1
(43) Pub. Date: May 17, 2007

(54) Thermoplastic polyurethanes and method of fabricating the same

(75) Inventors: Ruei-Shin Chen, Changhua County (TW); Chih Kuang Chang, Kaohsiung County (TW); Yih-Her Chang, Hsinchu City (TW); Fan Jeng Tsai, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/339,445

(22) Filed: Jan. 26, 2006

(30) Foreign Application Priority Data
Nov. 17, 2005 (TW) 94140418

(51) Int. Cl. C08G 18/00

(52) U.S. Cl. 528/44

(57) ABSTRACT

A thermoplastic polyurethane. The thermoplastic polyurethane includes a hydrophilic polyether-polyol, an aromatic polyisocyanate, and an aliphatic polyester-polyol, wherein the polyurethane has a NCO/OH ratio of about 0.9˜1.2.

### BACKGROUND OF THE INVENTION

1. Field of the Invention

The invention relates to a polymer material, and in particular to a thermoplastic polyurethane and a fabrication method thereof.

2. Description of the Related Art

Thermoplastic polyurethane (TPU) is a soft elastomeric resin with high tensile strength, wearproof, low temperature resistance, and strong adhesion. The polyurethane, also meeting environmental requirements due to decomposability, and not use of solvent during processing, has been widely applied in textiles and ready-made clothes. A thin (<20 μm) and uniform (±15%) film can be obtained using a blown film method. In the method, raw material with optimal melting fluidity and narrow molecular weight distribution is required to control the resulting film quality. Current water vapor permeable polyurethane is the most common solvent-based polyurethane fabricated by coating. Thermoplastic polyurethanes produced in resin factories are also injected-level or extruded-level products. None of them, however, meet the requirements for the blown film processing. Thus, qualified polyurethane must be imported, at increased costs. Thus, development of blown-level water vapor permeable polyurethane fabrication is required.

Sufficient tensile strength of blown-level polyurethane is required to withstand pulling force during blowing. Aromatic polyol can be conducted to polyurethane to increase film strength. Molecular structure, however, may thus be destroyed due to simultaneously increased resin melting temperature, resulting in deterioration of film quality. Also, the active aromatic polyol may produce undesired side reactions and products with various molecular weights, reducing stability of processing. Also, softness and water vapor permeability of the film may be simultaneously reduced thereby. Additionally, addition of multi-functional-group polyol can improve resin strength due to formation of cross-linking structure. The cross-linking structure, however, may deteriorate melting fluidity, causing difficulty of operation. Furthermore, gel particles formed by the cross-linking structure may block apparatus or cause defective film such as protrusion, scar, or fish eye.

Current water vapor permeable polyurethane fabrication methods mainly comprise adding hydrophilic functional groups to polymer structure. Other accessory methods such as adding absorbent powders, creating pores, forming cross-linking structure, or adding aromatic compounds also increase water vapor permeability or film strength. There are many patents related to water vapor permeable polyurethane, mainly comprising use of additives or film modification by back-end processing. Few, however, relate to film composition.

U.S. Pat. No. 6,790,926 discloses a water vapor permeable polyurethane, and fabrication and application thereof. The polyurethane comprises a polyether-polyol containing high weight percentage of ethylene oxide (comprising polyethylene glycol (PEG) and 4,4-methylene bisphenyl diisocyanate (MDI)), a small molecule chain extender, and an araliphatic diol. Addition of the araliphatic diol containing benzene structure increases resin strength and reduces adhesion between films.

US 2004/092,696 discloses a polyurethane comprising a polyether intermediate containing ethylene oxide (containing two terminal hydroxyl functional groups) and a chain extender such as araliphatic diol. The polyurethane provides high melting temperature, high tensile strength, and anti-static electricity. This patent also discloses a textile combined with the polyurethane, capable of elongation, high water vapor permeability, thermal resistance, and processibility.

US 2003/195,293 discloses an aqueous and water vapor permeable polyurethane comprising a polyol containing ethylene oxide. No emulsifying agent or amine neutralizer is required during water dispersion due to formation of the hydrophilic ethylene oxide chains, preventing pollution from solvents or small molecule vaporized substances. Wound dressing materials or textiles combined therewith also provide high water vapor permeability. Additionally, film strength is improved by addition of other polymer materials.

JP 2000/220,076 discloses a solvent-based polyurethane containing at least 20 wt % ethylene oxide. To avoid over-concentration of ethylene oxide in soft segment, a diol chain extender containing ethylene oxide is further added to increase ethylene oxide content in hard segment. Thus, water vapor permeable groups are uniformly distributed in the polyurethane, increasing film strength.

DE 4,442,380 discloses a polyurethane comprising one or more polyether polyurethanes, one of which is a water vapor permeable polyethylene glycol polyurethane, and other polyurethanes selected by strength requirements. Ethylene oxide content and mixing ratio among polyether polyurethanes are defined. Polyester polyurethanes, however, are not suitable for use due to lower water vapor permeability.

DE 4,339,475 discloses a polyurethane having 35˜60 wt % ethylene oxide comprising polyether-polyol. To facilitate coating, melt flow index less than 70 is required. The small molecule chain extender comprises ether-diol and ester-diol. Large molecule polyester-polyol, however, is not used.

U.S. Pat. No. 5,254,641 discloses a water vapor permeable polyurethane film comprising a polyurethane containing polyethylene glycol (PEG) with a hardness of 75 A˜92 A and 5˜20 wt % polyether-amide or polyether-ester. Film strength can be effectively improved by addition of the polyether-amide or polyether-ester.

U.S. Pat. No. 5,283,112 discloses a polyurethane comprising a hydrophilic polyethylene glycol (PEG) and a hydrophobic polydimethyl siloxane (PDMS). During fabrication, phase separation is more complete due to different hydrophilicity of components, resulting in stronger film. Also, softness of polyurethane and its adhesion to substrate can be improved by addition of PDMS.

EP 335,276 discloses a water vapor permeable non-yellowing polyurethane comprising an aliphatic or cyclo-aliphatic diisocyanate, a polyether-polyol containing ethylene oxide, and a diol. The soft polyurethane having optimal physical modulus can be obtained, suitable for use in extrusion processing.

GB 2,087,909 discloses a solvent-based polyurethane. A short-chain diol is first mixed with exceeding diisocyanate to form a pre-polymer. Next, a polyethylene glycol (PEG) is added thereto. A polyurethane containing 25˜40 wt % polyethylene glycol is thus formed. Film strength is improved by formation of the longer hard segment pre-polymer comprising the diol and diisocyanate.

WO 9,000,969, WO 9,000,180, and GB 2,157,703 disclose a two-component or pre-polymer-type polyurethane comprising a polyether-polyol such as polyethylene glycol (PEG), a chain extender, and a cross-linking reagent. The resulting polyurethane has exceeding NCO and provides low viscosity. Additionally, film strength is increased by formation of cross-linking structure.

### BRIEF SUMMARY OF THE INVENTION

The invention provides a thermoplastic polyurethane comprising a hydrophilic polyether-polyol, an aromatic polyisocyanate, and an aliphatic polyester-polyol, wherein the polyurethane has a NCO/OH ratio of about 0.9˜1.2.

The invention also provides a method of fabricating a thermoplastic polyurethane comprising mixing a hydrophilic polyether-polyol and an aliphatic polyester-polyol, adding a compound having at least two isocyanate-reactive groups, and adding an aromatic polyisocyanate to form a thermoplastic polyurethane, wherein the polyurethane has a NCO/OH ratio of about 0.9˜1.2.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a thermoplastic polyurethane comprising a hydrophilic polyether-polyol, an aromatic polyisocyanate, and an aliphatic polyester-polyol. The polyurethane has a NCO/OH ratio of about 0.9˜1.2.

The polyether-polyol has a C/O ratio of about 2˜2.4. The polyether-polyol may have an average molecular weight of about 800˜4,000 and comprise polyethylene glycol (PEG), polypropylene glycol (PPG), or polytetramethylene glycol (PTMG). In the polyurethane, the polyether-polyol has a weight ratio of about 20˜60%.

The polyester-polyol may have an average molecular weight of about 800˜4,000 and comprise poly(1,4-butylene adipate) (PBA). In the polyurethane, the polyester-polyol has a weight ratio of about 10˜40%.

The polyisocyanate may comprise 4,4-methylene bisphenyl diisocyanate (MDI) or toluene diisocyanate (TDI) and have a weight ratio of about 20˜40% in the polyurethane.

The thermoplastic polyurethane may further comprise a compound having at least two isocyanate-reactive groups, such as 1,4-butane diol (1,4-BD). The compound may be a chain extender and have a molecular weight less than 800. In the polyurethane, the compound has a weight ratio of about 5˜15%.

The polyurethane may have a molecular weight of about 150,000˜250,000, preferably 180,000˜200,000, a polydispersity index (PDI) of about 1.6˜2.4, preferably 1.8˜2.0, a melt flow index of about 6,000˜12,000 ps, preferably 8,000˜10,000 ps, a water vapor permeability of about 2,500˜15,000g/m²/day, a tensile strength of about 250˜500 kg/cm², an elongation of about 500˜750%, and a 100% modulus of about 30˜70 kg/cm².

Unlike conventional polyurethane composed of aromatic polyol or multi-functional-group polyol to increase film mechanical strength, the invention provides a thermoplastic polyurethane composed of hydrophilic polyether-polyol and aliphatic polyester-polyol capable of formation of more hydrogen bonds and intermolecular interaction forces. Thus, the novel thermoplastic polyurethane provides higher water vapor permeability and better film processibility, overcoming the issues associated with blown film processing.

The invention also provides a method of fabricating a thermoplastic polyurethane, comprising the following steps. A hydrophilic polyether-polyol and an aliphatic polyester-polyol are mixed at 40˜100° C. The polyester-polyol has a concentration of about 20˜60 wt %. Next, a compound having at least two isocyanate-reactive groups is added. Finally, an aromatic polyisocyanate is added to form a thermoplastic polyurethane. The polyurethane has a NCO/OH ratio of about 0.9˜1.2.

### EXAMPLE 1

135 g polyethylene glycol (PEG) and 45 g poly(1,4-butylene adipate) (PBA) were mixed in a reaction tank with stirring under nitrogen gas at 69° C. Next, 20.25 g 1,4-butane diol (1,4-BD), a chain extender, was added and continuously stirred. 78.75 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 48 wt % PEG2000, 17 wt % PBA2000, 7wt % 1,4-BD, and 28 wt % MDI. The polyurethane had 100% modulus of 31 kg/cm², elongation of 740%, tensile strength of 310 kg/cm², and water vapor permeability of 13,000 g/m²/day.

### EXAMPLE 2

120 g polyethylene glycol (PEG) and 40 g poly(1,4-butylene adipate) (PBA) were mixed in a reaction tank with stirring under nitrogen gas at 67° C. Next, 21.6 g 1,4-butane diol (1,4-BD), a chain extender, was added and continuously stirred. 80 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 46 wt % PEG2000, 15 wt % PBA2000, 8 wt % 1,4-BD, and 31 wt % MDI. The polyurethane had 100% modulus of 40 kg/cm², elongation of 700%, tensile strength of 240 kg/cm², and water vapor permeability of 12,000 g/m²/day.

### EXAMPLE 3

110 g polyethylene glycol (PEG) and 55 g poly(1,4-butylene adipate) (PBA) were mixed in a reaction tank with stirring under nitrogen gas at 62° C. Next, 24.75 g 1,4-butane diol (1,4-BD), a chain extender, was added and continuously stirred. 89.38 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 39 wt % PEG2000, 20 wt % PBA2000, 9 wt % 1,4-BD, and 32 wt % MDI. The polyurethane had 100% modulus of 50 kg/cm², elongation of 650%, tensile strength of 320 kg/cm², and water vapor permeability of 10,500 g/m²/day.

### EXAMPLE 4

100 g polyethylene glycol (PEG) and 58.8 g poly(1,4-butylene adipate) (PBA) were mixed in a reaction tank with stirring under nitrogen gas at 65° C. Next, 25.1 g 1,4-butane diol (1,4-BD), a chain extender, was added and continuously stirred. 89.7 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 37 wt % PEG2000, 21 wt % PBA2000, 9 wt % 1,4-BD, and 33 wt % MDI. The polyurethane had 100% modulus of 61 kg/cm², elongation of 630%, tensile strength of 330 kg/cm, and water vapor permeability of 8,800 g/m²/day.

### EXAMPLE 5

97 g polyethylene glycol (PEG) and 60.6 g poly(1,4-butylene adipate) (PBA) were mixed in a reaction tank with stirring under nitrogen gas at 67° C. Next, 27.3 g 1,4-butane diol (1,4-BD), a chain extender, was added and continuously stirred. 96.5 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 34 wt % PEG2000, 22 wt % PBA2000, 10 wt % 1,4-BD, and 34 wt % MDI. The polyurethane had 100% modulus of 67 kg/cm², elongation of 570%, tensile strength of 280 kg/cm, and water vapor permeability of 8,200 g/m²/day.

### EXAMPLE 6

91 g polyethylene glycol (PEG) and 75 g poly(1,4-butylene adipate) (PBA) were mixed in a reaction tank with stirring under nitrogen gas at 64° C. Next, 23.6 g 1,4-butane diol (1,4-BD), a chain extender, was added and continuously stirred. 87.5 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 33 wt % PEG2000, 26 wt % PBA2000, 9 wt % 1,4-BD, and 32 wt % MDI. The polyurethane had 100% modulus of 53 kg/cm², elongation of 510%, tensile strength of 480 kg/cm², and water vapor permeability of 8,000 g/m²/day.

### Example 7

80 g polyethylene glycol (PEG) and 80 g poly(1,4-butylene adipate) (PBA) were mixed in a reaction tank with stirring under nitrogen gas at 62° C. Next, 25.2 g 1,4-butane diol (1,4-BD), a chain extender, was added and continuously stirred. 90 g 4,4-methylene bisphenyl diisocyanate (MDI) was finally added and rapidly stirred, then the mixture was exothermic and drew out at 120° C. The result was then cured in an oven at 80° C. for 24 hours. Thus, a water vapor permeable thermoplastic polyurethane was obtained.

The thermoplastic polyurethane comprised 29 wt % PEG2000, 29 wt % PBA2000, 9 wt % 1,4-BD, and 33 wt % MDI. The polyurethane had 100% modulus of 64 kg/cm², elongation of 570%, tensile strength of 370 kg/cm², and water vapor permeability of 2,600 g/m²/day.

### COMPARATIVE EXAMPLE 1

160 g polyethylene glycol (PEG) was added in a reaction tank under nitrogen gas at 74° C. Next, 21.6 g 1,4-butane diol (1,4-BD), a chain extender, was added and continuously stirred. 80 g 4,4-methylene bisphenyl diisocyanate (MDI) was finally added and rapidly stirred, then the mixture was exothermic and drew out at 120° C. The result was then cured in an oven at 80° C. for 24 hours. Thus, a thermoplastic polyurethane was obtained.

The thermoplastic polyurethane comprised 61 wt % PEG2000, 8 wt % 1,4-BD, and 31 wt % MDI. The polyurethane had 100% modulus of 35 kg/cm ², elongation of 750%, tensile strength of 150 kg/cm², and water vapor permeability of 14,000 g/m²/day.

Compared to conventional polyethylene glycol polyurethane without PBA, the inventive polyurethane provides higher tensile strength and maintains high water vapor permeability. Accordingly, resin strength effectively improved by addition of PBA is demonstrated. These experimental data are recited in Table 1. Other modified polyurethane fabrication methods may comprise alteration of adding order of raw material, use of solvent or not, batch synthesis, or twin screw extrusion, but are not limited thereto.

TABLE 1

| | | | | | Property | | | |
|---|---|---|---|---|---|---|---|---|
| Composition | | | | | 100% | | Tensile | Water vapor |
| | PEG2000 | PBA2000 | 1,4-BD | MDI | modulus | Elongation | strength | permeability |
| No. | (wt %) | (wt %) | (wt %) | (wt %) | (kg/cm²) | (%) | (kg/cm²) | (g/m²/day) |
| Comparative | 61 | 0 | 8 | 31 | 35 | 750 | 150 | 14,000 |
| example 1 | | | | | | | | |
| Example 1 | 48 | 17 | 7 | 28 | 31 | 740 | 310 | 13,000 |
| Example 2 | 46 | 15 | 8 | 31 | 40 | 700 | 240 | 12,000 |
| Example 3 | 39 | 20 | 9 | 32 | 50 | 650 | 320 | 10,500 |
| Example 4 | 37 | 21 | 9 | 33 | 61 | 630 | 330 | 8800 |
| Example 5 | 34 | 22 | 10 | 34 | 67 | 570 | 280 | 8200 |
| Example 6 | 33 | 26 | 9 | 32 | 53 | 510 | 480 | 8000 |
| Example 7 | 29 | 29 | 9 | 33 | 64 | 570 | 370 | 2600 |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermoplastic polyurethane, comprising
a hydrophilic polyether-polyol;
an aromatic polyisocyanate; and
an aliphatic polyester-polyol, wherein the polyurethane has a NCO/OH ratio of about 0.9˜1.2.

2. The thermoplastic polyurethane as claimed in claim 1, wherein the polyether-polyol has a C/O ratio of about 2˜2.4.

3. The thermoplastic polyurethane as claimed in claim 1, wherein the polyether-polyol comprises polyethylene glycol (PEG), polypropylene glycol (PPG), or polytetramethylene glycol (PTMG).

4. The thermoplastic polyurethane as claimed in claim 1, wherein the polyether-polyol has a weight ratio of about 20˜60%.

5. The thermoplastic polyurethane as claimed in claim 1, wherein the polyester-polyol has an average molecular weight of about 800˜4,000.

6. The thermoplastic polyurethane as claimed in claim 1, wherein the polyester-polyol comprises poly(1,4-butylene adipate) (PBA).

7. The thermoplastic polyurethane as claimed in claim 1, wherein the polyester-polyol has a weight ratio of about 10˜40%.

8. The thermoplastic polyurethane as claimed in claim 1, further comprising a compound having at least two isocyanate-reactive groups.

9. The thermoplastic polyurethane as claimed in claim 1, wherein the polyurethane has a molecular weight of about 150,000˜250,000.

10. The thermoplastic polyurethane as claimed in claim 1, wherein the polyurethane has a polydispersity index (PDI) of about 1.6˜2.4.

11. The thermoplastic polyurethane as claimed in claim 1, wherein the polyurethane has a water vapor permeability of about 2,500˜15,000 g/m²/day.

12. The thermoplastic polyurethane as claimed in claim 1, wherein the polyurethane has a tensile strength of about 250˜500 kg/cm².

13. The thermoplastic polyurethane as claimed in claim 1, wherein the polyurethane has an elongation of about 500˜750%.

14. The thermoplastic polyurethane as claimed in claim 1, wherein the polyurethane has a 100% modulus of about 30˜70 kg/cm².

15. A method of fabricating a thermoplastic polyurethane, comprising
mixing a hydrophilic polyether-polyol and an aliphatic polyester-polyol;
adding a compound having at least two isocyanate-reactive groups; and
adding an aromatic polyisocyanate to form a thermoplastic polyurethane,
wherein the polyurethane has a NCO/OH ratio of about 0.9˜1.2.

16. The method of fabricating a thermoplastic polyurethane as claimed in claim 15, wherein the polyester-polyol has concentration of about 10˜40 wt %.

17. The method of fabricating a thermoplastic polyurethane as claimed in claim 15, wherein the polyether-polyol has a C/O ratio of about 2˜2.4.

18. The method of fabricating a thermoplastic polyurethane as claimed in claim 15, wherein the polyether-polyol comprises polyethylene glycol (PEG), polypropylene glycol (PPG), or polytetramethylene glycol (PTMG).

19. The method of fabricating a thermoplastic polyurethane as claimed in claim 15, wherein the polyester-polyol has an average molecular weight of about 800˜4,000.

20. The method of fabricating a thermoplastic polyurethane as claimed in claim 15, wherein the polyester-polyol comprises poly(1,4-butylene adipate) (PBA).
